(19) United States
(12) Patent Application Publication
(10) Pub. No.: US 2013/0289961 A1
(43) Pub. Date: Oct. 31, 2013

(54) Methods For Producing Fluids From Geological Formation

(71) Applicants: Indranil Ray, Sugar Land, TX (US); Richard E. Lewis, Frisco, TX (US); Oliver Clinton Mullins, Ridgefield, CT (US); Colin Longfield, Sugar Land, TX (US); Bruce MacKay, Sugar Land, TX (US); Paul George, Denver, CO (US); Rashmi Bhanulal Bhavsar, Houston, TX (US); Chris Wilkinson, Houston, TX (US)

(72) Inventors: Indranil Ray, Sugar Land, TX (US); Richard E. Lewis, Frisco, TX (US); Oliver Clinton Mullins, Ridgefield, CT (US); Colin Longfield, Sugar Land, TX (US); Bruce MacKay, Sugar Land, TX (US); Paul George, Denver, CO (US); Rashmi Bhanulal Bhavsar, Houston, TX (US); Chris Wilkinson, Houston, TX (US)

(73) Assignee: SCHLUMBERGER TECHNOLOGY CORPORATION, Sugar Land, TX (US)

(21) Appl. No.: 13/825,058

(22) PCT Filed: Sep. 20, 2011
(86) PCT No.: PCT/US2011/052368

§ 371 Date: Jul. 9, 2013

Related U.S. Application Data
(60) Provisional application No. 61/384,429, filed on Sep. 20, 2010.

(51) Int. Cl. G01V 9/00

(52) U.S. Cl. CPC G01V 9/00
USPC 703/10

(57) ABSTRACT

Embodiments disclosed herein relate to reservoir characterization techniques and methods for accurately predicting scale tendencies of formation fluids, developed with the newly discovered phenomena that extreme downhole conditions affect the properties of reservoir fluids, including both the brine and dense hydrocarbon gas phases. In one aspect, there is disclosed a method for producing fluids from a geological formation. The method comprises inputting at least one property of a geological formation into an equation of state (EOS) model. The EOS model accounts for bound water, a high temperature effect on the brine and a high temperature effect on the dense gas phase. The EOS model is solved to determine a character of fluids contained in the geological formation, and inputting a production condition or a plurality of production conditions into the EOS model. A character of the fluids is determined based on the determined character of the fluids in the geological formation and the input production conditions. The solution can be output to a display device. Planning of the production of fluids from the geological formation can be performed. Production conditions can be controlled or adjusted.

### BACKGROUND

Historically, deposition of inorganic scale is chiefly a flow assurance problem associated with the volume and salinity of produced water. Hydrocarbons are often co-mingled with salty water in producing formations. Formation waters, or “connate waters”, contain ions and the static mixture of ions is equilibrated over very long time scales. The solubilities of various salts in water are strongly dependent on parameters like pressure, temperature, and pH. The equilibrium achieved by formation water is perturbed during production as the fluid's physical situation changes—pressure drops can allow dissolved gases to partition into different phases, and this partitioning can change pH. At the same time, temperature and pressure are changing. The tendency for formation waters to deposit solid salts as the ions become less soluble in water is called the scaling tendency. Salting of formations affects productivity of wells, both on land and offshore. Currently, to overcome the salting issues, formations are stimulated and chemicals are used to inhibit scaling.

The tendency for formation waters to deposit solid salts during production of a well is sometimes calculated based on established thermodynamic parameters, such as solubility products, Kₛₚ, for salts across a relatively limited temperature range and a pH range as described in SPE 132237, and on fluid flow from the reservoir, as described in SPE80252.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

It has now been discovered that reservoir fluids may depart from ideal behavior, especially at the higher temperatures and pressures that are being encountered as deeper wells are being drilled. Specifically, it has now been discovered that at high pressure, high temperatures conditions (such as greater than 300° F. and 15 ksi), dense hydrocarbon gases may solvate halides, screen ions, and exhibit ionic activity. Previous techniques to characterize a formation, focusing on water as the only phase solvating salts, thus mischaracterize the fluids in the well and inaccurately model the tendency of the formation fluids to deposit solids.

In one aspect, embodiments disclosed herein relate to a method for producing fluids from a geological formation. The method comprises inputting at least one property of a geological formation into an equation of state (EOS) model. The EOS model accounts for bound water, a high temperature effect on the brine and a high temperature effect on the dense gas phase. The method further comprises solving the EOS model to determine a character of fluids contained in the geological formation, and inputting a production condition or a plurality of production conditions into the EOS model. The method further solves the EOS model to determine a character of the fluids based on the determined character of the fluids in the geological formation and the input production conditions. The solution can be output to a display device. Planning of the production of fluids from the geological formation can be performed. Production conditions can be controlled or adjusted.

Other aspects and advantages will be apparent from the following description and the appended claims.

### BRIEF DESCRIPTION OF DRAWINGS

FIG. 1 illustrates a diagrammatical representation of the components of a geological formation.

FIG. 2 is a flow chart for a method of developing an Equation of State model that accounts for a high temperature effect, a pressure effect, or a high pressure effect on a reservoir fluid according to embodiments disclosed herein.

FIG. 3 is a flow chart for a method of characterizing or simulating a reservoir or reservoir fluid, using an Equation of State model that accounts for a high temperature effect, a pressure effect, or a high pressure effect on a reservoir fluid, according to embodiments disclosed herein.

FIG. 4 illustrates a schematic diagram of a petroleum reservoir analysis system useful in characterizing or simulating a reservoir or reservoir fluid according to embodiments disclosed herein.

FIG. 5 is a flow chart for a method of characterizing or simulating a reservoir or reservoir fluid based on measurements made using the system of FIG. 3 (or other measurement devices or methods), using an Equation of State model that accounts for a high temperature effect, a pressure effect, or a high pressure effect on a reservoir fluid, according to embodiments disclosed herein.

FIGS. 6 and 7 graphically compare conductivity as a function of temperature for an Equation of State model according to embodiments disclosed herein accounting for a high temperature effect, a pressure effect, or a high pressure effect on a reservoir fluid, with a model that does not account for any of a high temperature effect, a pressure effect, or a high pressure effect on a reservoir fluid.

FIG. 8 graphically illustrates resistivity well log data at high pressure and high temperature conditions.

FIG. 9 graphically illustrates porosity well log at high pressure and high temperature conditions.

FIGS. 10 and 11 illustrate a combined schematic and flow diagram of reservoir production.

FIG. 12 is a flow chart of a process for predicting scale tendencies of a formation fluid and planning, controlling, or adjusting well production according to embodiments herein.

FIG. 13 is a graphical representation of how the Ba²⁺ concentration in a dense gas phase may change as a function of temperature and pressure.

### DETAILED DESCRIPTION

It has now been discovered that reservoir fluids may depart from ideal behavior, especially at the higher temperatures and pressures that are being encountered as deeper wells are being drilled. For example, at high pressure high temperature conditions, the water and hydrocarbons are present in a formation as a dense multicomponent or multiphase fluid, where the brine contains salt ions, and it has been discovered that the dense hydrocarbon gas phase may also contain substantial amounts of salt ions, even when the methane content of the fluid exceeds 90%. Thus, previous methods to determine the character of a well and related modeling and simulation techniques may mischaracterize reservoirs and fluids contained therein.

Embodiments disclosed herein relate to reservoir characterization techniques and methods for accurately predicting scale tendencies of formation fluids, developed with the newly discovered phenomena that extreme downhole conditions affect the properties of reservoir fluids, including both the brine and dense hydrocarbon gas phases. More specifically, embodiments disclosed herein relate to reservoir characterization techniques and methods for accurately predicting scale tendencies of formation fluids, the techniques and methods accounting for a high temperature effect on the brine and the dense hydrocarbon gas phases, a pressure effect or high pressure effect on the brine and dense hydrocarbon gas phases, or a combination thereof. The proper characterization of reservoir fluids and their salt/ion content, including the dense hydrocarbon gas phase, may thus allow for improvements in one or more of well completion, well stimulation, scale inhibition, preventing liquid dropout, and well production, among others, as discussed in more detail below.

Reservoir characterization techniques and methods for predicting scale tendencies for embodiments disclosed herein may include modeling or simulation of a reservoir, reservoir fluid, or phase of a reservoir fluid based on known component data (e.g., molecular weights and other physical or chemical properties), as well as data stored or input based on laboratory measurements, downhole measurements, research data presented in publications, well logs, or other relevant data sources as may be known or recognizable to one skilled in the art.

As used herein, “high temperature effect” is defined as deviation(s) from ideal behavior of a reservoir, reservoir fluid, or a phase of a reservoir fluid, at elevated temperatures, such as greater than 300° F., 350° F., 400° F., 450° F., 500° F. or greater in various embodiments. As used herein, “pressure effect” is defined as the influence pressure may have on the behavior of a reservoir, reservoir fluid, or phase of a reservoir fluid. As used herein, “high pressure effect” is defined as deviation(s) from ideal behavior of a reservoir, reservoir fluid, or a phase of a reservoir fluid, at elevated pressures, such as greater than 15 ksi, 20 ksi, 25 ksi, 30 ksi or greater in various embodiments. Models or algorithms used to estimate or predict the character of a reservoir, reservoir fluid, or phase of a reservoir fluid in embodiments disclosed herein thus include functions or derivations to more accurately calculate or estimate one or more properties of the reservoir, reservoir fluid, or phase of a reservoir fluid accounting for one or more of these effects.

Reservoir fluids are known to those of ordinary skill in the art to contain various phases and components. For example, reservoirs may include an aqueous phase (e.g., water and dissolved salts), a hydrocarbon gas phase (e.g., hydrogen, methane, ethane, ethylene, and other light hydrocarbons, as well as carbon dioxide, hydrogen sulfide, and numerous other compounds), and a liquid hydrocarbon phase (e.g., pentanes, hexanes, etc., which may include heavy hydrocarbons, such as asphaltenes), as well as carbon dioxide, hydrogen sulfide, among numerous other compounds. Thermodynamic models used in embodiments herein may rely on a database of stored properties for one or more of these components, which may include one or more of molecular formula, molar weight, as well as pressure-volume-temperature data (such as one or more of phase envelopes, boiling points, melting points, density, viscosity, solubility, etc.). Reservoirs at high temperature and high pressure may also include a dense gas phase (e.g., methane, ethane, ethylene, other light hydrocarbons, carbon dioxide, and hydrogen sulfide, among numerous other compounds).

Thermodynamic models have now been developed that account for the high temperature effects on properties of the brine, including the non-ideal behavior discovered at extreme downhole conditions. Functions, algorithms, or derivations used to account for the high temperature effects on the brine that may be included in embodiments of the thermodynamic model may account for changes in one or more of molecular interactions, solubility constants or solubility characteristics of water (solvating power), density, electronegativity, dipole moment, heat capacity, hydrogen bonding, miscibility, as well as electrophoretic/relaxation effects and ion pairings, among others, as a function of temperature, including deviations from ideal behavior that may be estimated, measured, or observed at elevated downhole temperatures.

Embodiments of the thermodynamic model may also account for the effect of pressure on the brine, and thus on the geological formation and the character of the reservoir fluid. Heretofore the effect of pressure on conductivity/resistivity or various other properties of a downhole fluid has not been accounted for in efforts to determine the character of a reservoir. Thermodynamic models according to embodiments disclosed herein may include functions or derivations to account for the effect of pressure on the brine. Such functions or derivations, in some embodiments, may also account for deviations from ideal behavior at elevated pressures (the high pressure effect). Functions, algorithms, or derivations used to account for the pressure effects and high pressure effects on the brine that may be included in embodiments of the thermodynamic model may account for changes in one or more of molecular interactions, solubility constants or solubility characteristics of water (solvating power), density, electronegativity, dipole moment, heat capacity, hydrogen bonding, miscibility, as well as electrophoretic/relaxation effects and ion pairings, among other properties of the brine, as a function of temperature, including deviations from ideal behavior that may be estimated, measured, or observed at elevated downhole pressures.

For example, the pressure effect on solubility of a salt in water may be represented by the following equation:

$${( \frac{δ ln {N}_{i}}{δ P} )}_{T} = - \frac{( {V}_{i , aq} - {V}_{i , cr} )}{RT}$$

where the index i iterates the components, Nᵢ is the mole fraction of the i^{th} component in the solution, P is the pressure, the index T refers to constant temperature, V_{i,aq} is the partial molar volume of the i^{th} component in the solution, V_{i,cr} is the partial molar volume of the i^{th} component in the dissolving solid, and R is the universal gas constant.

It has also been found that hydrocarbon gases, particularly the dense gas phase, especially at high temperature and high pressure, may solvate ions and exhibit conductivity. In previous models, the resistivity of the dense gas phase was assumed infinite (no conductivity). However, at relatively high temperatures and/or pressures, the dense gas phase may indeed contribute to the conductivity of the formation fluid, and thus may be accounted for to properly characterize a reservoir and the fluids contained therein.

Thermodynamic models have now been developed that account for the high temperature effects on properties of the dense gas phase, including the non-ideal behavior discovered at extreme downhole conditions. Functions, algorithms, or derivations used to account for the high temperature effects on the dense gas phase that may be included in embodiments of the thermodynamic model may account for changes in one or more of molecular interactions, solubility constants or solubility characteristics of water (solvating power), density, electronegativity, dipole moment, heat capacity, hydrogen bonding, miscibility, as well as electrophoretic/relaxation effects and ion pairings, among others, as a function of temperature, including deviations from ideal behavior that may be estimated, measured, or observed at elevated downhole temperatures.

Embodiments of the thermodynamic model may also account for the effect of pressure on the dense gas phase, and thus on the geological formation and the character of the reservoir fluid. Heretofore the effect of pressure on conductivity/resistivity or various other properties of a downhole fluid has not been accounted for in efforts to determine the character of a reservoir. Thermodynamic models according to embodiments disclosed herein may include functions or derivations to account for the effect of pressure on the dense gas phase. Such functions or derivations, in some embodiments, may also account for deviations from ideal behavior at elevated pressures (the high pressure effect). Functions, algorithms, or derivations used to account for the pressure effects and high pressure effects on the dense gas phase that may be included in embodiments of the thermodynamic model may account for changes in one or more of molecular interactions, solubility constants or solubility characteristics of water (solvating power), density, electronegativity, dipole moment, heat capacity, hydrogen bonding, miscibility, as well as electrophoretic/relaxation effects and ion pairings, among other properties of the dense gas phase, as a function of temperature, including deviations from ideal behavior that may be estimated, measured, or observed at elevated downhole pressures.

With respect to ion pairing and other effects that may be accounted for in the model, embodiments of the model used to determine or estimate the character of a reservoir may also include functionalities relative to numerous dissolved salts or ions. Heretofore, conductivity/resistivity algorithms were based on sodium chloride dissolved in the aqueous phase. However, brines and dense gases found in reservoirs around the world may contain other ions or mixtures of ions, such as sodium-, magnesium-, calcium-, potassium-, and strontium-chlorides, bromides, borates, bicarbonates, and sulfates, among other salts that may be present in underground reservoirs as may be known to those of ordinary skill in the art. Embodiments of the model used to characterize a reservoir may thus account for differences in conductivity/resistivity that may occur based on the ions present in the brine, based on ions present in the dense gas as well as the high temperature effects, pressure effects, and/or high pressure effects on the ions and the brine and the dense gas.

Archie's equation, shown below, relates resistivity of a geological formation to its porosity and brine saturation and is sometimes used to estimate hydrocarbon saturation of the geological formation.

1/Rₜ=Φ²/a[S_{w}²/R_{w}] (Archie's equation)

where Rₜ is the total resistivity in the formation, Φ is the porosity of the formation, S_{w} is the water saturation of the formation and R_{w} is the water resistivity. Heretofore, the conductivity of a fluid-saturated rock was presumed to be primarily a function of the brine content of the reservoir fluid. Archie's equation treats formation and hydrocarbon resistivities as infinite; however, at relatively high temperatures and/or pressures, the dense gas phase may indeed contribute to the conductivity of the formation fluid, and thus may be accounted for to properly characterize a reservoir and the fluids contained therein.

Embodiments of the model used to characterize a reservoir may thus account for the effect of conductivity in the dense gas phase, based on a modified Archie's equation as shown below in Equations 1 or 2.

1/Rₜ=Φ²/a[S_{w}²/R_{w}+S_{g}²/R_{G}] Equation 1

or

1/Rₜ=Φ²/a[S_{w}²/R_{w}+(1−S_{w})²/R_{G}] Equation 2

where S_{G} is the dense gas phase saturation and R_{G} is the resistivity of the dense gas phase.

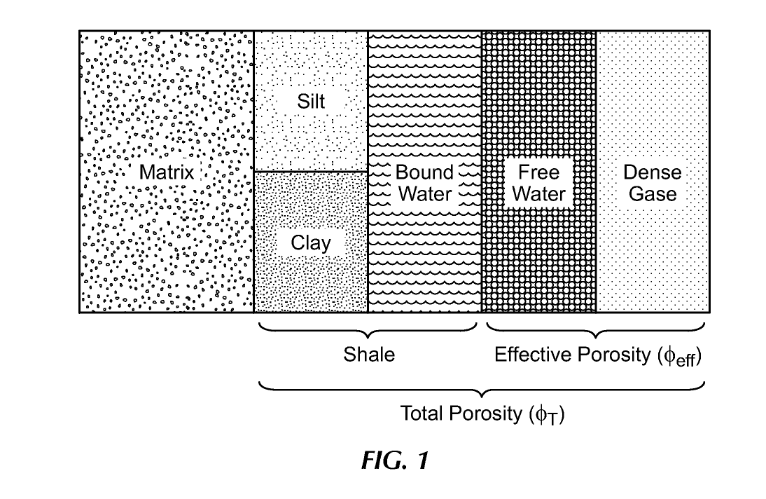

Reservoirs are known to contain shaly-sand including clay minerals and clay components which may retain water as illustrated in FIG. 1. This highly conductive water, commonly referred to as bound water, increases the value of the conductivity measurements, while decreasing the resistivity measurements. Methods to account for the conductivity effect of bound water in shaly sands have been determined to provide a more accurate evaluation of water saturation. The Dual Water Model, as shown below, takes into account an ionic double-layer in the clay components of shaly sand stones.

C_{T}=Φ²[S_{WB}C_{WB}+(1−S_{WB})C_{W}]

or

1/R_{T}=Φ²[S_{WB}/R_{WB}+(1−S_{WB})/R_{W}

where C_{T} is total conductivity, Φ is total porosity, S_{WB} is bound water saturation, C_{WB} is conductivity of bound water, C_{W} is conductivity of brine, R_{T} is total resistivity, R_{WB} is resistivity of bound water, and R_{W} is resistivity of brine.

Inconsistencies have been detected in the dual water model when applied to shaly sands models, which has now been discovered to be a result from the unaccounted presence of conductive water (relative humidity) or ions (dissolved salts) in the dense gas phase at high pressure and high temperature conditions as described above.

Embodiments of the model used to characterize a reservoir may thus account for the conductivity effect of bound water, along with the effect of high temperature, pressure and high pressure on the brine and the dense gas phase, thereby providing a more accurate evaluation of water saturation. A modified dual water equation is derived to account for the resistivity of the bound water, brine, and dense gas phase, including the effect of HPHT conditions on the brine and the dense gas phase. A modified dual water equation may be assumed as follows:

(1−S_{WB})=S_{W}+S_{G}

and

(1−x)(1−S_{WB})=S_{G}

where S_{WB} is the bound water saturation, S_{W} is the brine saturation and S_{G} is the dense gas phase saturation.

Embodiments of the model used to characterize a reservoir may thus account for the conductivity effect of bound water associated with shaly sands, while also accounting for the conductivity of both the brine of the dense gas phase, including the effect of HPHT conditions on the brine and the dense gas phase in a modified dual water equation. The derivation of the modified dual water equation is as follows:

$$\frac{1}{{R}_{T}} = {φ}_{T}^{2} [ \frac{{S}_{WB}}{{R}_{WB}} + \frac{x ( 1 - {S}_{WB} )}{{R}_{W}} + \frac{( 1 - x ) ( 1 - {S}_{WB} )}{{R}_{G}} ]$$

$$i . e . \frac{1}{{R}_{T} {φ}_{T}^{2}} - \frac{{S}_{WB}}{{R}_{WB}} = [ \frac{x ( 1 - {S}_{WB} )}{{R}_{W}} + \frac{( 1 - x ) ( 1 - {S}_{WB} )}{{R}_{G}} ]$$

$$i . e . [ \frac{1}{{R}_{T} {φ}_{T}^{2}} - \frac{{S}_{WB}}{{R}_{WB}} ] = [ \frac{x ( 1 - {S}_{WB} )}{{R}_{W}} + \frac{( 1 - {S}_{WB} )}{{R}_{G}} - \frac{x ( 1 - {S}_{WB} )}{{R}_{G}} ]$$

$$i . e . [ \frac{1}{{R}_{T} {φ}_{T}^{2}} - \frac{{S}_{WB}}{{R}_{WB}} - \frac{( 1 - {S}_{WB} )}{{R}_{G}} ] = [ \frac{x ( 1 - {S}_{WB} )}{{R}_{W}} - \frac{x ( 1 - {S}_{WB} )}{{R}_{G}} ]$$

$$i . e . [ \frac{1}{{R}_{T} {φ}_{T}^{2}} - \frac{{S}_{WB}}{{R}_{WB}} - \frac{( 1 - {S}_{WB} )}{{R}_{G}} ] = x ( 1 - {S}_{WB} ) [ \frac{1}{{R}_{W}} - \frac{1}{{R}_{G}} ]$$

$$x = [ \frac{\frac{1}{{R}_{T} {φ}_{T}^{2}} - \frac{{S}_{WB}}{{R}_{WB}} - \frac{( 1 - {S}_{WB} )}{{R}_{G}}}{( 1 - {S}_{WB} ) [ \frac{1}{{R}_{W}} - \frac{1}{{R}_{G}} ]} ] \\ ∴ {S}_{W} = x ( 1 - {S}_{WB} ) = [ \frac{\frac{1}{{R}_{T} {φ}_{T}^{2}} - \frac{{S}_{WB}}{{R}_{WB}} - \frac{( 1 - {S}_{WB} )}{{R}_{G}}}{\frac{1}{{R}_{W}} - \frac{1}{{R}_{G}}} ]$$

$$\begin{matrix}∴ {S}_{G} = 1 - {S}_{WB} - {S}_{W} \\ = 1 - {S}_{WB} - [ \frac{\frac{1}{{R}_{T} {φ}_{T}^{2}} - \frac{{S}_{WB}}{{R}_{WB}} - \frac{( 1 - {S}_{WB} )}{{R}_{G}}}{\frac{1}{{R}_{W}} - \frac{1}{{R}_{G}}} ]\end{matrix} \\ ∴ {S}_{WB} = [ \frac{{φ}_{Shale}}{{φ}_{Log}} ] or {V}_{Shale}$$

where R_{T} is total resistivity, R_{WB} is resistivity of bound water, R_{W} is resistivity of brine, R_{G} is resistivity of dense gas phase, Φ_{Shale} is porosity of the shale, Φ_{Log} is total porosity.

Petroleum samples are often classified into fluid types that include black oils, volatile oils, retrograde condensates, wet gases, and dry gases. These fluid types may be distinguished based on carbon number, for example, and are often related to different considerations for their exploitation. Models used in embodiments for reservoir characterization disclosed herein may rely on a database of stored properties or averaged properties for one or more of these compound groups, which may include one or more of weight percentage, molar weight, molar percentage, carbon number range, as well as pressure-volume-temperature data (such as one or more of phase envelopes, boiling ranges, melting ranges, API gravity, formation volume factor, compressibility factor, density, viscosity, solubility, etc.).

In embodiments, at least one property of the brine may be derived from the stored data and one or more empirical relationships may be derived from an analysis of the pressure-volume-temperature data. In embodiments, at least one property of the dense gas phase may be derived from the stored data and one or more empirical relationships may be derived from an analysis of the pressure-volume-temperature data. In embodiments, at least one property of the bound water may be derived from the stored data and an empirical relationship may be derived from an analysis of the pressure-volume-temperature data. Empirical relations are derived from an analysis of the stored properties for the compounds and/or groups of compounds (e.g., regression analyses or other numerical methods). For derivation of the empirical relation, one may use transforms having smooth and continuous first and second derivatives for algorithmic estimation of properties. Accordingly, the high temperature effect and/or high pressure effect may be accounted for in the model by use of one, two, three, or more transforms encompassing the overall temperature ranges and/or pressure ranges experienced during drilling and production of reservoirs. In some embodiments, for example, the high temperature effect may be accounted for based on an additive function (i.e., property=f(temperature)+f(high temperature effect)). In other embodiments or for other empirical relations, the high temperature effect may be accounted for by delineation of the algorithm over discrete temperature intervals (i.e., if x<T≦y, property=f(T), if y<T≦z, property=f′(T), etc.). In yet other embodiments, various “constants” used for calculating properties of compounds or interactions between compounds or groups of compounds, such as binary interaction parameters, may be input as a function of temperature or may be input as a constant having different values for discrete temperature ranges. Similar considerations may be used for the pressure effect and high pressure effect.

In addition to the empirical relations derivable from the stored data, the property(ies) and empirical relationships can be used to generate an Equation of State model for predicting one or more properties of the reservoir, the reservoir fluid, or a phase of the reservoir fluid, where the equation of state model may incorporate, may be tuned, or may be modified to incorporate the bound water, the high temperature, pressure, and/or high pressure effects as recognizable or derived in the empirical relations. As used herein, an Equation of State model capturing the high temperature effect includes one or more equations to calculate chemical and/or physical properties of a system. The equations of the Equation of State model may include the above-derived empirical relationships, may be equations based on the above-derived empirical relationships, and may also include various equations from various Equations of State known to those of skill in the art. Examples of Equations of State which may be used, tuned, and/or modified may include the Sen-Goode-Sibbit EOS, the Redlich-Kwong EOS, the Soave-Redlich-Kwong EOS, Peng Robinson EOS, and others known to one of ordinary skill in the art. The properties of the brine, dense gas phase, and bound water that may be predicted using an Equation of State model may include conductivity, resistivity, density, viscosity, compressibility, composition (e.g., dissolved hydrocarbon content, salinity/ion concentration, ion/salt type(s), etc.), phase activity, pH, free energy, heat capacity, entropy, enthalpy, chemical potentials, and diffusion coefficients, among others.

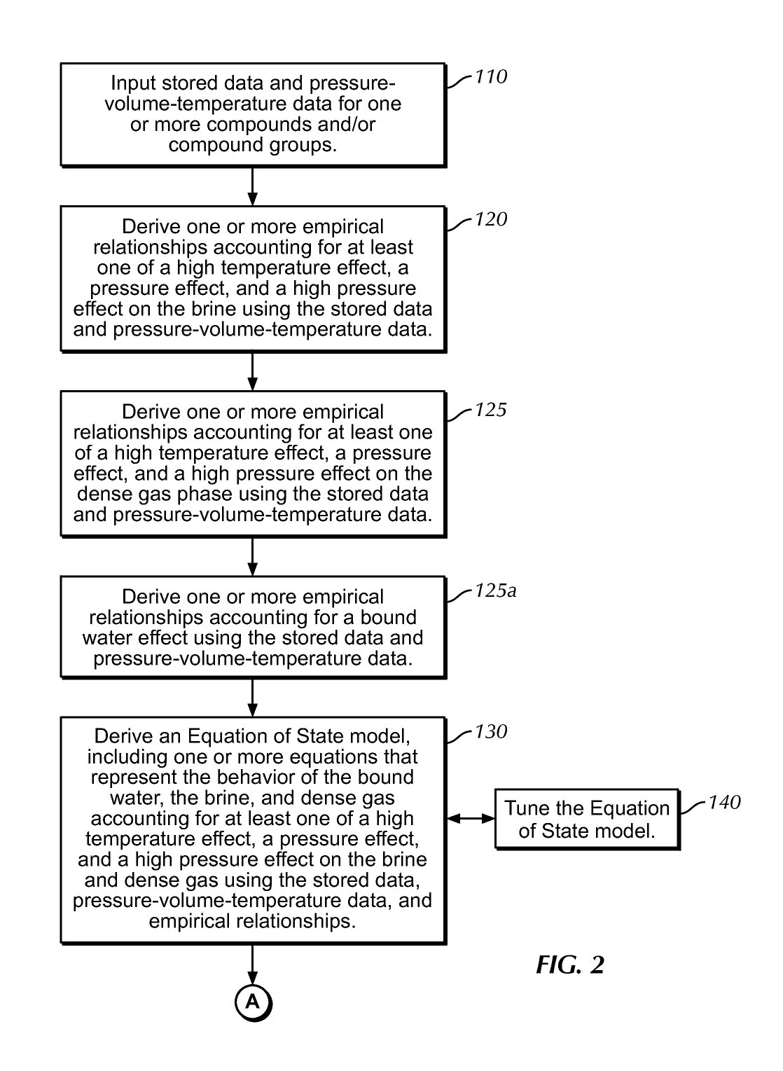

Thus, embodiments disclosed herein include a method for generating a model to characterize a wellbore, where the model incorporates at least one of bound water, a temperature effect, a pressure effect, and a high pressure effect. Referring now to FIG. 2, a methodology to characterize a reservoir, reservoir fluid, or phase(s) of a reservoir fluid according to embodiments disclosed herein is illustrated. In 110, stored data and pressure-volume-temperature data for one or more compounds and/or compound groups may be provided as an input. In 120, the input stored data and pressure-volume-temperature data may be used to derive one or more empirical relationships accounting for at least one of a high temperature effect, a pressure effect, and a high pressure effect on the brine. In 125, the input stored data and pressure-volume-temperature data may be used to derive one or more empirical relationships accounting for at least one of a high temperature effect, a pressure effect, and a high pressure effect on the dense gas phase. In 125a, the input stored data and pressure-volume-temperature data may be used to derive one or more empirical relationships accounting for bound water. In 130, the stored data, pressure-volume-temperature data, and empirical relationships derived therefrom may be used to derive an Equation of State model including one or more equations that represent the behavior of the bound water, brine and dense gas phase and account for at least one of a high temperature effect, a pressure effect, and a high pressure effect on the brine and the dense gas phase. The equations of the Equation of State model(s) may be self-derived, may be part of a commercially available software package, or may be a modification of equations provided in commercially available software packages.

Following derivation of the Equation of State, the Equation of State may optionally be tuned in 140. Tuning of the Equation of State model may be performed by adjusting one or more of the input data, such as critical temperature or critical pressure, binary interaction parameters, volume translation parameters, and constants that may have been generated in deriving the empirical relationships, among others. Adjustment of the one or more variables may be performed for model validation, such as to properly characterize a known reservoir, or may be performed to better simulate or estimate characteristics of an unknown reservoir based on any downhole data that may be obtained during drilling or production of the well. As noted above, tuning may include adjusting various parameters to be a function of temperature or pressure or to have values pertaining to one or more discrete temperature or pressure ranges so as to account for the high temperature effect, pressure effect, and/or high pressure effect. Adjustment of the one or more constants that may have been generated in deriving the empirical relationships, such as the binary interaction parameters, and volume translation parameters, may be done to account for the effect of high temperature, pressure or high pressure on the constants.

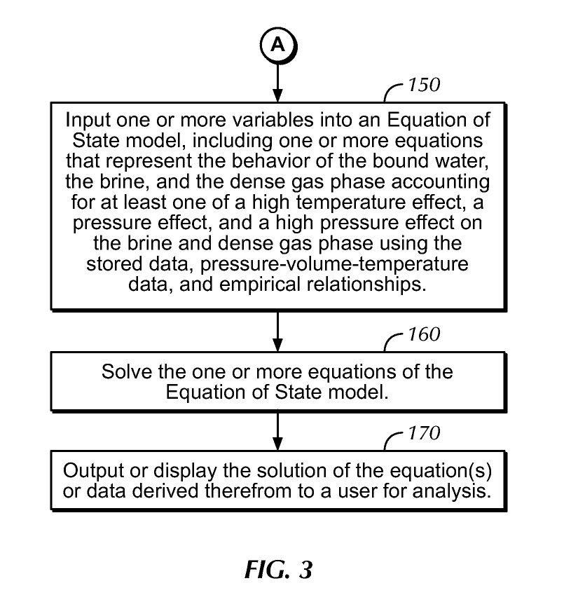

Following derivation of the Equation of State model, as well as any validation or tuning that may be desired, the models may then be used to simulate or characterize a reservoir, reservoir fluid, or phase(s) of a reservoir fluid, as illustrated in FIG. 3. In 150, one or more values/variables for at least one property of a reservoir, reservoir fluid, or phase(s) of a reservoir fluid may be input into the Equation of State model by a user, such as reservoir temperature, reservoir pressure, conductivity/resistivity, salinity brine properties such as ion/salt type(s), etc. The equations of the Equation of State model may then be solved, such as by a computer-implemented iteration scheme (e.g., Newton-Raphson iteration or other iteration schemes as known to those of skill in the art), in 160, to determine or estimate one or more additional properties of the reservoir, reservoir fluid, or phase(s) of a reservoir fluid. The one or more properties determined or estimated may include properties such as brine content, hydrocarbon content, bound water content, conductivity/resistivity of the brine, pressure-volume-temperature predictions, phase activity, density, viscosity, pH, free energy, heat capacity, entropy, enthalpy, phase compositions, chemical potentials, diffusion coefficients, as well as may other variables. In 170, the solution of the equation (s) or data derived therefrom, such as charts or graphs, may then be output or displayed to a user for analysis. For example, the solution, charts, or graphs may be output to a display device, such as a monitor, or may be printed using a printer associated with the computer used to solve the equations of the Equation of State model.

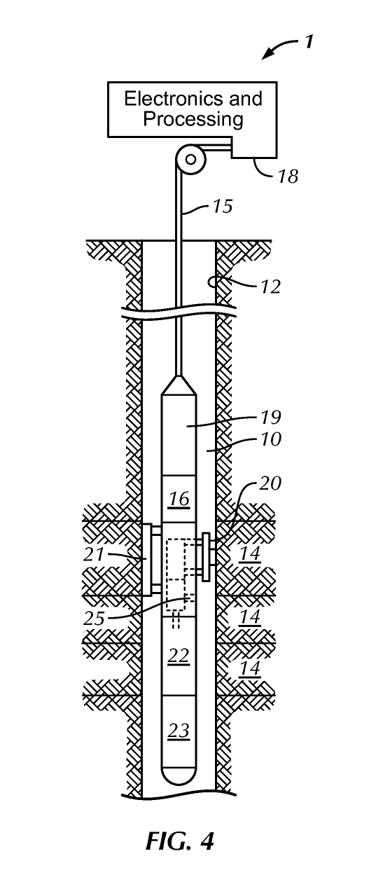

As noted above, following derivation of the Equation of State model, as well as any validation or tuning that may be desired, the models may then be used to simulate or characterize a reservoir, reservoir fluid, or phase(s) of a reservoir fluid, including characterization of reservoirs encountered during a drilling operation. For example, in some embodiments, a petroleum reservoir analysis system as shown in FIG. 4 may be used to obtain or infer at least one property of the reservoir, such as temperature, pressure, porosity, conductivity/resistivity, or other data that may be obtained or inferred during drilling or using a downhole analysis tool. The system 1 includes a borehole tool 10 suspended in the borehole 12 from the lower end of a multiconductor cable 15 that is spooled in a usual fashion on a suitable winch (not shown) on the formation surface. The cable 15 is electrically coupled to an electrical control system 18 on the formation surface. The tool 10 includes an elongated body 19 which encloses the downhole portion of the tool control system 16. The elongated body 19 also carries a selectively extendable fluid admitting assembly 20 and a selectively extendable tool anchoring member 21 which are respectively arranged on opposite sides of the tool body. The fluid admitting assembly 20 is equipped for selectively sealing off or isolating selected portions of the wall of the borehole 12 such that pressure or fluid communication with the adjacent geological formation 14 is established. The geological formation 14 may include various strata which may have various phases associated with them. In an embodiment, the geological formation may include an aqueous phase and a hydrocarbon phase. The aqueous phase is sometimes the brine within the geological formation. Also included with tool 10 may be means for determining the downhole pressure and temperature (not shown) and a fluid analysis module 25 through which the obtained fluid flows. The fluid may thereafter be expelled through a port (not shown) or it may be sent to one or more fluid collecting chambers 22 and 23 which may receive and retain the fluids obtained from the formation. Control of the fluid admitting assembly 20, the fluid analysis module 25, and the flow path to the collecting chambers is maintained by the control systems 16 and 18. As will be appreciated by those skilled in the art, the surface-located electrical control system 18 includes data processing functionality (e.g., one or more microprocessors, associated memory, and other hardware and/or software) to implement embodiments as described herein. The electrical control system 18 can also be realized by a distributed data processing system wherein data measured by the tool 10 is communicated (in some embodiments, in real time) over a communication link (in some embodiments, a satellite link) to a remote location for data analysis as described herein. The data analysis can be carried out on a workstation or other suitable data processing system (such as a computer cluster or computing grid).

An example of a borehole tool suitable for capturing fluid samples for data analysis is the Modular Dynamic Formation Tester (MDT) tool, available from Schlumberger Technology Corporation of Sugar Land, Tex., USA. The MDT tool provides a controlled channel of hydraulic communication between the reservoir fluid and the wellbore and allows withdrawal of small amounts of formation fluid through a probe that contacts the reservoir rock (formation). Such downhole fluid sampling is advantageous because the sampling is more accurate downhole. More specifically, in the event that the sampling pressure is above the saturation pressure, the fluid will be in a single phase ensuring that the original composition is being analyzed. For pressures below the saturation pressure, a measurement of the properties of the liquid phase in the oil zone and the associated gas above it will yield a more accurate sampling than a sample recombined at the surface. Indeed, it may be difficult to retain the sample in the state it exists downhole when it is retrieved to surface. Historically, fluid samples collected by well logging tools were brought to the surface for analysis in the laboratory. However, recent developments in the MDT tool have made possible the direct measurement of fluid properties downhole during the pump-out or sampling sequence, which is referred to herein as “downhole fluid analysis (DFA).” Details of the MDT tool and its capabilities for downhole fluid analysis may be obtained with reference to U.S. Pat. Nos. 3,859,851; 4,994,671; 5,167,149; 5,201,220; 5,266,800; and 5,331,156.

Downhole fluid analysis is advantageous because information is provided in real time, in contrast to a laboratory analysis that may take several days, or surface wellsite analysis that may result in undesirable phase transitions as well as the loss of certain constituents. A detailed description of the fluid properties is desirable for an accurate modeling of the fluids in the reservoir. Indeed, decisions such as the type of well completion, production procedures, and the design of the surface handling and processing facilities are affected by the characteristics of the produced fluids.

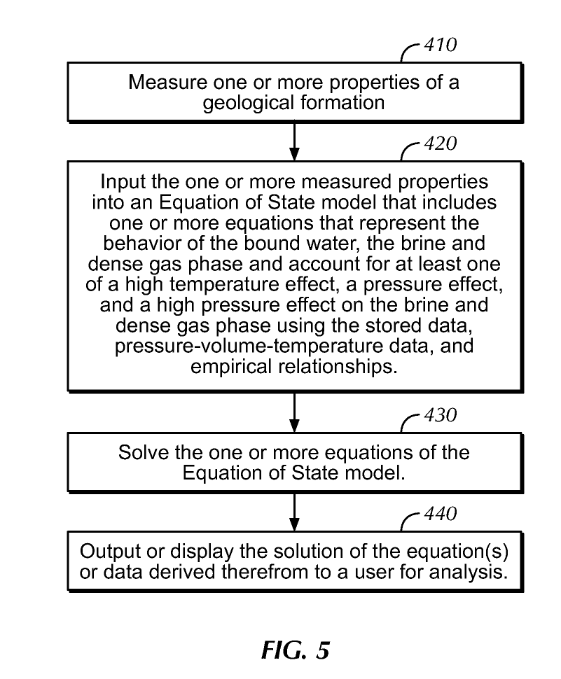

The apparatus of FIG. 4 may be employed with the methodology of FIG. 5 to characterize, estimate, simulate, and/or analyze one or more properties of the geological formations encountered during drilling as a function of pressure and temperature, including one or more of a high temperature effect, a pressure effect, and a high pressure effect. For example, the measurements taken using the system of FIG. 3 may be used to characterize the compositional components, the fluid properties, or other aspects of a reservoir of interest.

The downhole tool measures at least one first property of the geological formation in 410. The at least one first property may include, but is not limited to, the salinity of the reservoir fluid or a phase of the reservoir fluid, formation temperature and pressure, the types of ions present in the formation fluid or a phase of the formation fluid, the number of co-existing phases present (bound water, water/brine, hydrocarbon gases, hydrocarbon liquids), oil/water/gas ratios, and resistivity of the brine, among other measurable or quantifiable variables.

In 420, the one or more measured properties may then be input into an Equation of State model that includes one or more equations that represent the behavior of the bound water, brine and dense gas phase and account for at least one of a high temperature effect, a pressure effect and a high pressure effect on the brine and dense gas phase. In 430, the equations of the Equation of State may be solved, as described above, to determine at least one second property of the reservoir, reservoir fluid, or phase(s) of the reservoir fluid. The at least one second property may be, but is not limited to, bound water content, brine content, hydrocarbon content, resistivity of the brine, resistivity of the dense gas phase, resistivity of the bound water, phase activity, phase fugacity, density, viscosity, pH, free energy, heat capacity, entropy, enthalpy, phase compositions, chemical potentials, and diffusion coefficients. The at least one second property may also include, but is not limited to, salinity, formation temperature and pressure, types of ions present, and the number of coexisting phases present.

In 440, the solution of the equation (s) or data derived therefrom, such as charts or graphs, may then be output or displayed to a user for analysis. For example, the solution, charts, or graphs may be output to a display device, such as a monitor, or may be printed using a printer associated with the computer used to solve the equations of the Equation of State model.

In other embodiments, data input (stored data or PVT data) in embodiments disclosed herein may be generated using a high pressure high temperature testing apparatus. For example, a test apparatus including a view cell may be used to investigate, measure, or observe phase behavior of salts or other ions in brines and dense gases (including methane, CO₂, H₂S, etc. as described above) at extreme temperatures and/or pressures, as well as the phase behavior of mixtures of brine, dense gases, and/or heavier hydrocarbons (VLLE, SVLLE, etc.). Such laboratory testing apparatus may be used to measure the effects of high temperature and pressure on the brine and dense gas phases, providing data input to the model for deriving the high temperature, pressure, and/or high pressure effects, or may be used to estimate various parameters (binary interaction parameters, etc.) or to determine how such parameters may be modified to account for the high temperature, pressure, and/or high pressure effects.

In the manner described above, the character of a reservoir or reservoir fluid may be determined, estimated, or simulated, accounting for one or more of bound water, a high temperature effect on the brine, a pressure effect on the brine, a high pressure effect on the brine, a high temperature effect on the dense gas phase, a pressure effect on the dense gas phase, and a high pressure effect on the dense gas phase. Accurate determination of the character of the wellbore may provide valuable data and a means for properly and accurately estimating hydrocarbon reserves (gas and/or oil), viability for producing a reservoir (i.e., fluid-containing strata) encountered during drilling, as well as simulating production conditions that may allow an optimal recovery of hydrocarbons from the reservoir.

For example, once a reservoir and the fluids contained therein have been properly characterized, accounting for the various types of ions and the ionic content of the hydrocarbon dense gas phase and brine, the model may be used to accurately predict or promote an understanding of the relationship between pressure, temperature, and salt content of the dense gas phase, pressure temperature, and salt content of the brine, pressure, temperature, and heavy hydrocarbon (wax, asphaltenes, etc.) phase behavior, molecular interactions between the dense gas phase and the brine at various temperatures and pressures, and numerous other relations as may be envisioned by one skilled in the art. The model may thus allow insight to the phase behavior of the reservoir fluids during production, which in turn may be used to predict scale tendencies of a formation, plan completion and/or production of the formation to suppress, minimize, or reduce solids dropout or scaling, select production conditions to suppress, minimize, or reduce solids dropout or scaling, select appropriate control agents to suppress, minimize or reduce solids dropout or scaling, cause solids dropout or desalination of reservoir fluids in a controlled or controllable manner, as well as to estimate the dynamic behavior of the reservoir fluids under production conditions. These aspects of how thermodynamic models according to embodiments disclosed herein may be advantageously exploited are described in more detail below.

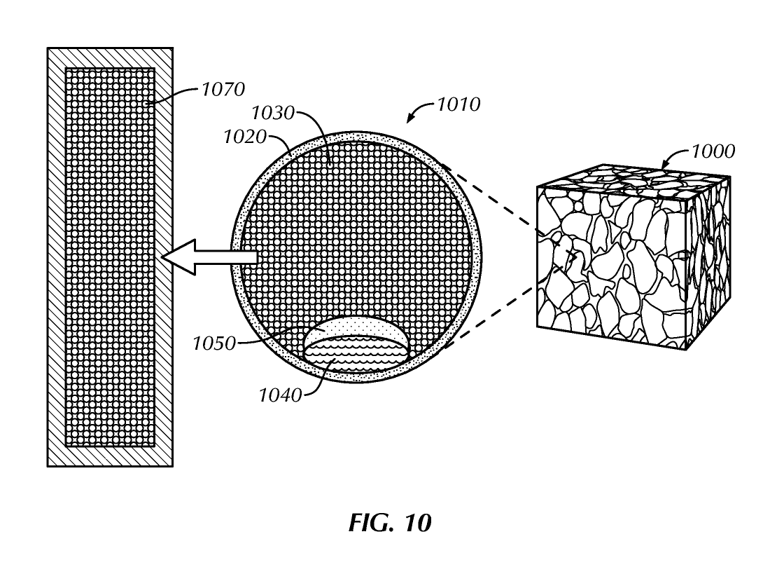

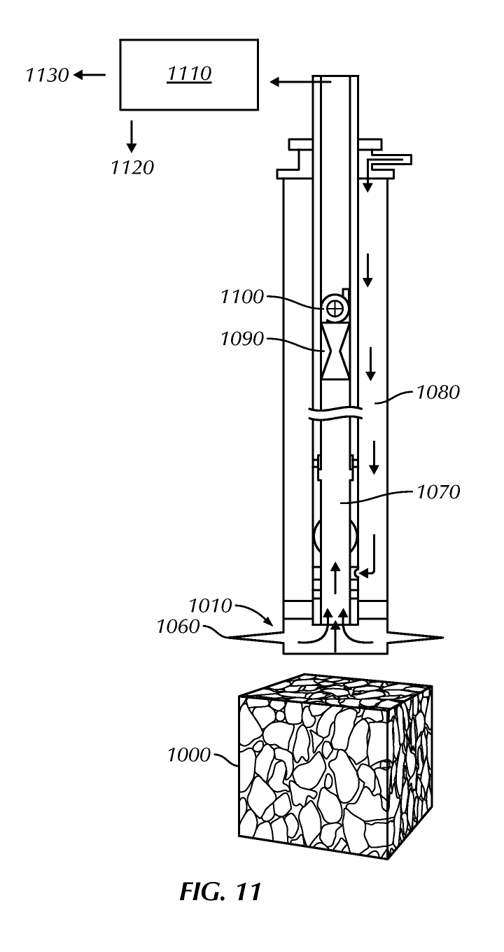

Referring now to FIGS. 10 and 11, where like numerals represent like parts, a combined schematic and flow diagram of reservoir production is illustrated. In the reservoir being produced, a porous geological formation 1000 may include one or more fluids 1010 interspersed throughout the pores of the formation, the geological formation being at a Reservoir Pressure, P_{R}, and a Reservoir Temperature, T_{R}. The fluids 1010 contained in the formation may include capillary bound water 1020, a dense gas phase 1030, which may include various hydrocarbons, hydrogen, hydrogen sulfide, carbon dioxide, water (e.g., miscible water/100% relative humidity), and various salts, as discussed above, a brine phase 1040, which may include water, salts, dissolved gases (carbon dioxide, hydrogen sulfide), and miscible hydrocarbons, and a condensate hydrocarbon phase 1050, which may include C₁ to Cₙ hydrocarbons, trace dissolved gases (carbon dioxide, hydrogen sulfide), and trace salts.

During production of the reservoir, these fluids 1010 traverse through the pores of the reservoir proximate a production zone 1060 and are collected in a wellbore 1070. Due to expansion or other effects on the reservoir fluid, the produced fluids 1010 may be at a temperature, T_{P}, and pressure, P_{P}, that are different than the reservoir pressure P_{R} and temperature T_{R}. The temperature, pressure, and overall composition of the produced fluids 1010 may additionally change as the fluid traverses up the wellbore. For example, the wellbore fluids may be contacted or admixed with one or more injected fluids 1080 that may be used to enhance production, such as for injection of scale inhibitors or other chemicals and aids commonly used during production. Additional changes in the wellbore fluid properties may also be encountered proximate or within valves and other choke points 1090, pumps 1100, and in separators 1110 and other equipment (not shown) used during the production operation, such as to separate a condensed and produced water fraction 1120 from a hydrocarbon fraction 1130, which may include condensates (oil) and gases (natural gas) contained in the reservoir.

Numerous events may occur during traversal of the reservoir fluids 1010 from the pores in the reservoir through the production zone 1060, wellbore 1070, choke points 1090, pumps 1100, and separators 1110, including temperature changes, pressure changes, compositional changes (i.e., admixture with production aids, hydrocarbon solids dropout, desalination, etc.), and phase settling or separation (i.e., commingling of dispersed water or condensate phases, which may impact the total interface area between the phases), among others.

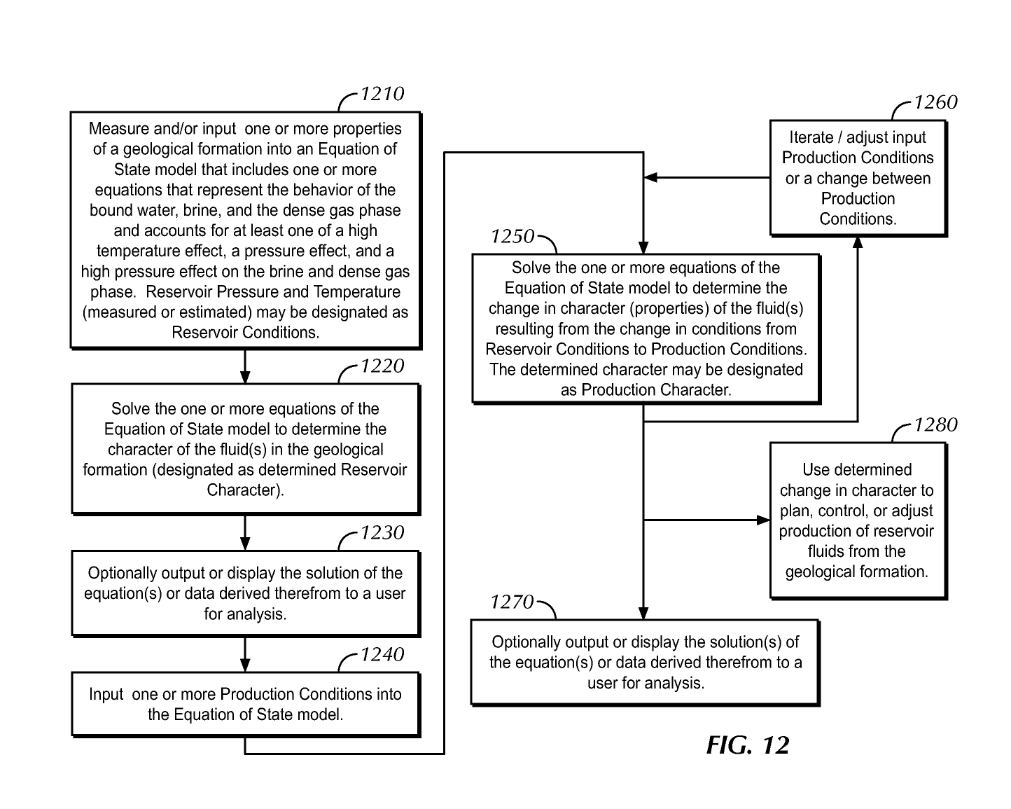

Referring now to FIG. 12, a flow diagram of a process for predicting scale tendencies of a formation fluid according to embodiments herein is illustrated. In 1210, one or more measured or previously determined or estimated properties of a geological formation may be input into an Equation of State model, as described above, accounting for bound water as well as temperature effects and pressure effects on the brine, and temperature effects and pressure effects on the dense gas phase. Inputs to the model may include, for example, Reservoir Conditions (temperature and pressure), phases, overall compositional data (such as from sample bombs depressured and analyzed or measured or estimated using downhole tools), ion/salt types, number of phases, phase ratios, and porosity, among others. The overall compositional data may include, for example, hydrocarbon content, hydrocarbon (C₁ to Cₙ) number and concentration data, overall salinity, water content, and gas (CO₂, H₂S, etc.) content, among others.

In 1220, the Equation of State model may be solved to accurately estimate the overall composition of the reservoir fluids, as well as the compositional makeup of the various phases that may be present, at Reservoir Conditions. For example, a sample bomb depressured and analyzed in a laboratory may provide relative gas, hydrocarbon, water, and salt contents, and the solution of the model may thus provide an accurate representation of the Reservoir Character, namely how the hydrocarbons are present or distributed at Reservoir Conditions (how much dense gas versus condensate hydrocarbons), how the water is present or distributed at Reservoir Conditions (bound, free, or with dense gas or condensate hydrocarbon phases), and how the salts may be dispersed between the various phases at Reservoir Conditions (i.e., concentration and type of ions present in the dense gas phase, concentration and type of ions present in the brine, etc.). The solution of the EOS model, the determined Reservoir Character, may then be saved for use in further simulations or modeling, output, or displayed for review and analysis by a user.

The determined Reservoir Character may then be used as an initial point for simulation of production conditions. In addition to the initial Reservoir Character, one or more Production Conditions (such as pressure, pressure drop, pressure drop rate, temperature, temperature drop, temperature drop rate, production rate, additive temperature, additive properties, additive flow rate, etc.) may be input into the EOS model in 1240. The equations of the EOS model may then be solved in 1250 to estimate the character or change in character of the reservoir fluid at the selected Production Conditions, designated herein as Production Character. The solution of the model may thus provide an accurate representation of the Production Character, namely how the hydrocarbons are present or distributed at Production Conditions (how much dense gas versus condensate hydrocarbons versus expanded gas or gas), how the water is present or distributed at Production Conditions (bound, free, or with dense gas or condensate hydrocarbon phases), and how the salts may be dispersed between the various phases at Production Conditions (i.e., concentration and type of ions present in the resulting dense gas or gas phase, concentration and type of ions present in the brine, etc.).

Depending upon the relative change in conditions (Production vs. Reservoir), for a given Reservoir Character the model may predict precipitation of a solid (waxy) hydrocarbon phase, precipitation of salts from the brine or the dense gas phase, a shift in compositions (water, hydrocarbons, and/or salts/ions) between phases, or other impacts resulting from the change in conditions. In some instances, the model may predict no precipitation.

In 1260, the input Production Conditions may be iteratively changed or adjusted to investigate the behavior of the reservoir fluid under different Production Conditions. In some cases, the Production Character may then be used as an initial point for simulation of production conditions, such as those that may be encountered further downstream, to determine the Production Character at downstream locations (looping 1250 to 1260 and back again). Results from one or more of the iterative investigations may be saved for cumulative analysis, output to a printer or other review medium, or displayed, such as on a monitor, for review and analysis by a user, in 1270.

The iterative loop (1250→1260→1250, etc.), whether user initiated or computer initiated, may thus provide numerous data points for consideration and analyses. Such data may then be used in 1280 to plan, control, or adjust conditions used for production of reservoir fluids from the geological formation.

For example, the loop may investigate change in Production Character resulting from changes in Production Conditions proximate a choke point. The results of the iterative analyses may illustrate conditions that result in a distinct salt or hydrocarbon precipitate phase, indicating potential for desalination and scale formation, and may also illustrate conditions that do not result in a distinct salt or hydrocarbon precipitate phase, indicating no or limited potential for desalination and scale formation. The mapping of the conditions and model results for the choke point may thus provide an estimate of the phase envelopes for the reservoir fluid(s), for example, and may then be used to estimate production rates, operating temperatures, pressures, pressure drops, temperature changes, and ranges of these that may provide for minimal or no precipitation of salts or other solids at the choke point. In other words, the EOS models of embodiments herein may thus provide estimates or guidelines for how production conditions may be controlled at the choke point to prevent desalination and scaling.

Similar mapping of conditions may be performed at other locations throughout the production process or along the production flow channel, including traversal of the reservoir fluid through the pores in the geological formation, flow of the reservoir fluid from the pores to the production zone, from the production zone to the inlet of the wellbore, during chemical addition in the wellbore, along long lengths of the wellbore, choke points, pumps, at the outlet of the wellbore (including pressure drops due to bends, tees, and valving), and during separation processes, among others. The mapping of the conditions and model results various points and sections of the production process may thus provide an estimate of the phase envelopes for the reservoir fluid(s) at such points and sections, for example, and may then be used to estimate production rates, operating temperatures, pressures, pressure drops, temperature changes, and ranges of these that may provide for minimal or no precipitation of salts or other solids at select locations of the production process or throughout the production process. Further, if it may be advantageous to cause desalination at a select location during the production process, such mapping may provide an estimate of the change in relevant conditions to result in desalination or a degree of desalination desired. In this manner, it may be possible to plan, control, or adjust production of reservoir fluids so as to result in minimal desalination and scaling throughout the production process.

Further with regard to controlling or adjusting production conditions, the character of the reservoir fluid may change over the lifetime of a reservoir. For example, the produced fluid may initially be hydrocarbon rich and gradually over time may change to being water rich. The model may thus also be used to reassess or remap the production conditions so as to account for changes in the produced fluid. In some embodiments, using an estimate of the size of the reservoir, the character of the reservoir proximate the production zone, and historical behavior of similar reservoirs, the EOS model may be used to provide a pseudo-dynamic mapping estimate of how the produced fluid may change over time, and/or how the production conditions may be changed to account for such changes in the produced fluid.

As noted above, chemical potentials, ion types, phase activities and other variables may be accurately determined or estimated using EOS models disclosed herein accounting for bound water, and high temperature and pressure effects on the brine and dense gas phase. Based on such information, the EOS model may be used to estimate how a scale inhibitor or other control agents may interact with the reservoir fluid and phases thereof during the production process. For example, an acrylamide polymer incorporating alkylphosphonate residues may be used as a control agent, but is a large molecule, whereas other control agents may be smaller molecules and may have different functional groups. The EOS model may be used to screen control agents to estimate their potential effectiveness for inhibiting scale formation for a given reservoir and/or under given production conditions, tailoring the control agent to the specific ions and composition of the produced fluid as well as the conditions used for production of the reservoir fluid. The EOS model may also be used to estimate a minimum effective amount of the control agent to inhibit scale formation, thus allowing one to effectively reduce or optimize control agent use and the associated costs.

As one skilled in the art would appreciate, simulations and modeling is based on steady state or pseudo-steady state conditions. In contrast, dissolution and precipitation are dynamic occurrences (i.e., an instantaneous change in conditions does not result in an instantaneous change in phase behavior). EOS models disclosed herein may incorporate algorithms that estimate the timescale over which desalination (precipitation of salts) may occur for a particular composition. For example, a brine or dense gas containing only sodium chloride may precipitate at a different rate than a brine or dense gas containing a mixture of ions, especially considering that some salts/ions/ion pairs may increase in solubility as temperature increases while others may decrease in solubility as temperature increases.

Estimates of the timescale over which precipitation occurs, or the amount of time to transition from one steady state condition to the next following a change in production conditions, may thus provide insight as to whether or not the actual change in production condition is relevant (will it impact production). For the specific case of producing a complex fluid comprising water, H₂S, CO₂, low molecular weight hydrocarbons, and dissolved salts from a porous medium or a network of natural (or induced) fractures, the fluid begins at one state described by parameters of pressure, temperature, and volume and ends at another state specified by another set of values. Along the way, certain phenomena (e.g. salt precipitation, phase separation) may or may not happen depending on whether the system is in the appropriate set of conditions for long enough—thus, salts that might have either precipitated or remained solvated within a mixture in the porous medium can actually move through the production pathway and precipitate fully far beyond where they would be expected based on steady state calculations or assumptions.

For example, a change in production conditions proximate the production zone (during flow from the formation into the wellbore) may take 0.1 seconds to achieve steady state (the resulting steady state precipitation level). If the production flow rates are such that precipitation will not occur proximate the production zone, but rather occur closer to or after a chemical injection point, the precipitation resulting due to the change in conditions proximate the production zone may be considered as operationally insignificant. In contrast, if such timescale indicates precipitation may occur in advance of a chemical injection point, the change in conditions proximate the production zone may be considered as operationally significant. In this manner, EOS models disclosed herein may provide an extra layer of kinetic information that can discriminates between conditions and states that will actually occur on the timescale of production, or even within the lifetime of the well. Such a kinetic model may enable better well production strategies, and provide better economic value from a producing well.

### EXAMPLES

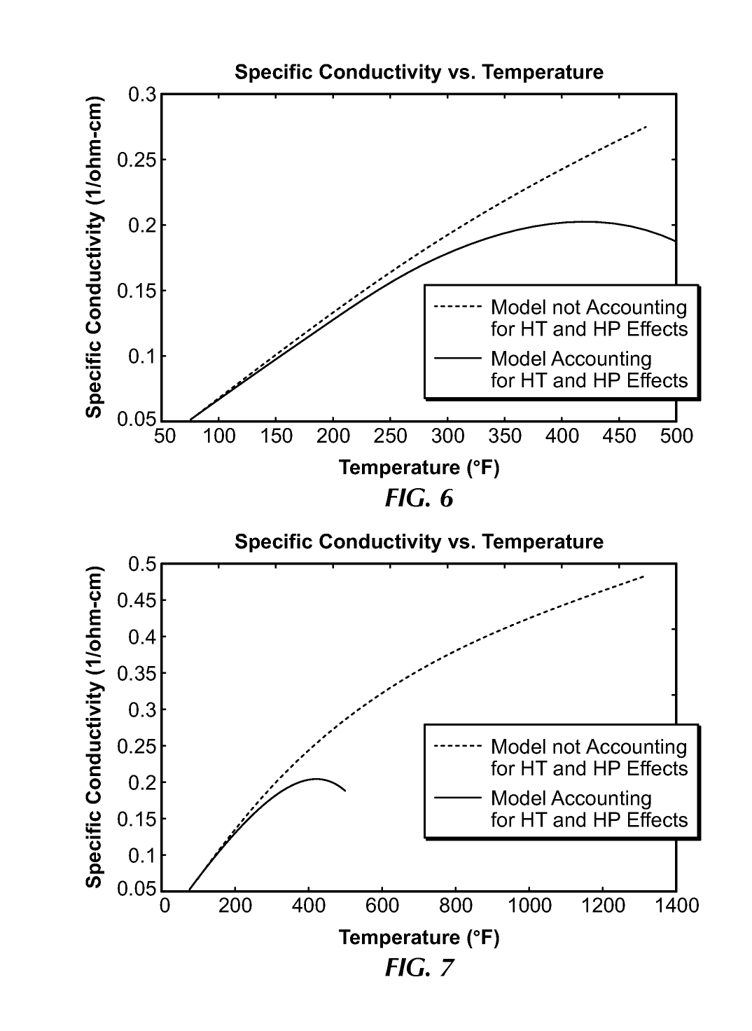

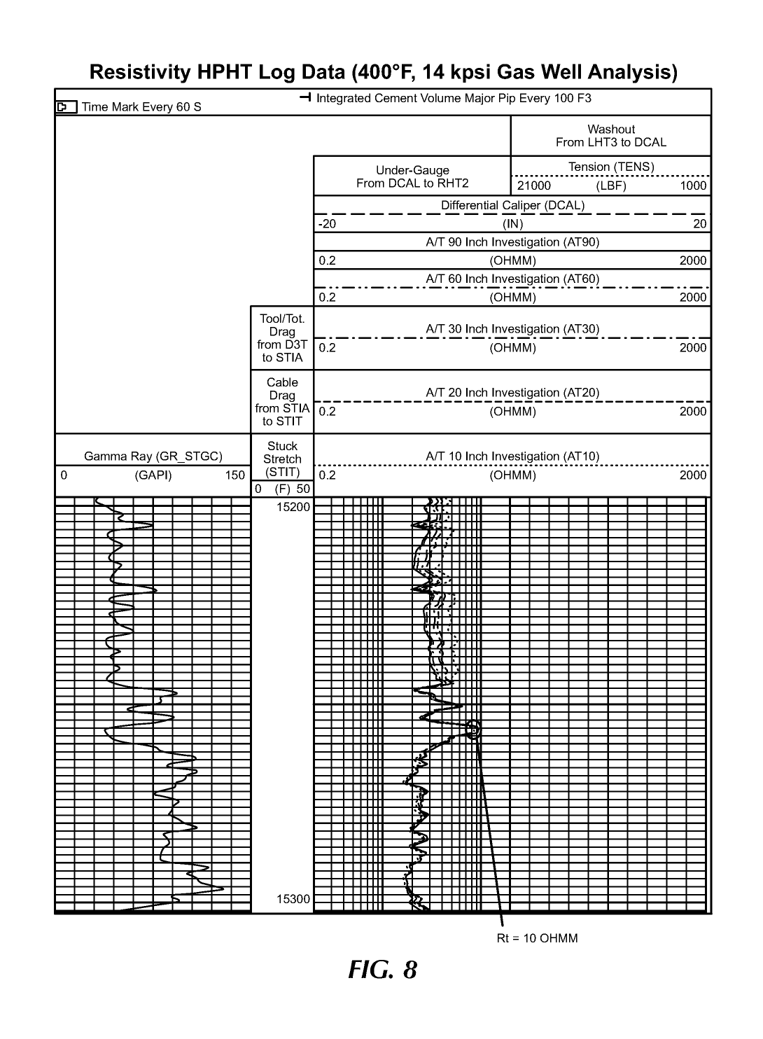

FIGS. 6 and 7 graphically compare conductivity as a function of temperature for an Equation of State model according to embodiments disclosed herein accounting for a high temperature effect, a pressure effect, and a high pressure effect on a reservoir fluid, with a model that does not account for any of a high temperature effect, a pressure effect, or a high pressure effect on a reservoir fluid. The model does not adequately predict the resistivity/conductivity of the brine solutions at higher temperatures and pressures. Accounting for electrophoretic/relaxation effects and ion pairing at high temperatures, differences on the order of 5% to 30% in conductivity are observed. Such large differences could lead to inadequate interpretation of the well data, and may potentially affect measurements in thin beds and formations with higher water cut (rocks with low hydrocarbon saturation). In other words, by accounting for a high temperature effect, pressure effect, and/or high pressure effect, it may be possible to more accurately predict hydrocarbon content of the formations encountered during drilling, as well as to more efficiently produce said formations.

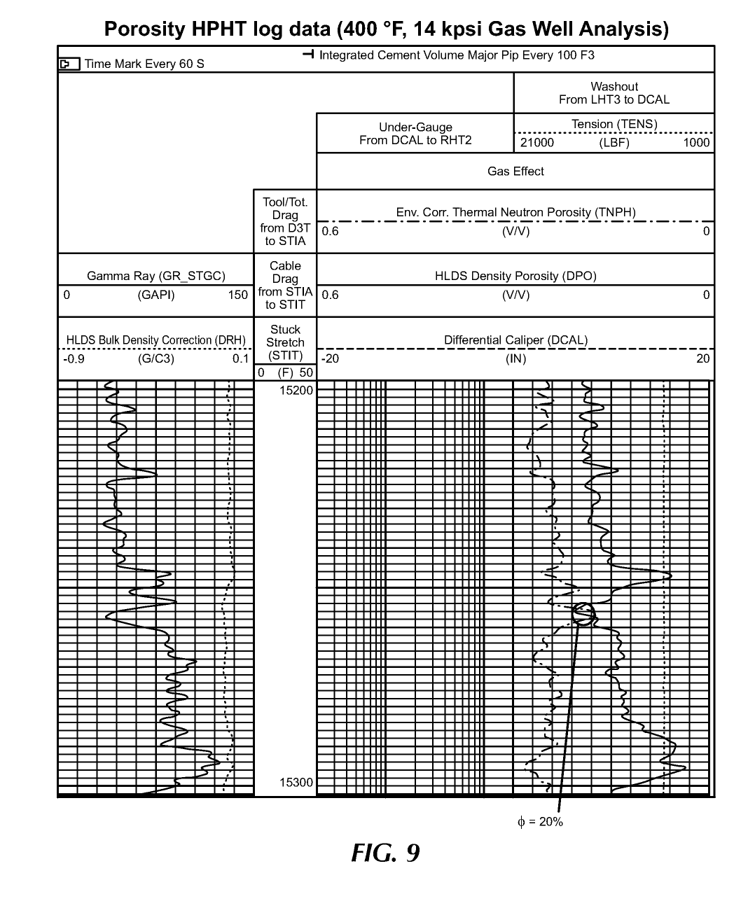

Next, the high temperature effect and the high pressure effect on reservoir fluids were accounted for in determining the hydrocarbon saturation of a reservoir using log data acquired from a gas well analysis at 400° F. and 14 k psi. From FIG. 8, the log data shows a total resistivity of 10 Ohm-m and from FIG. 9, a total porosity of 20%. Calculations were performed to compare the hydrocarbon saturation estimated using an Equation of State model according to embodiments disclosed herein accounting for a high temperature effect, a pressure effect, and a high pressure effect on the brine, with a model that does not account for any of a high temperature effect, a pressure effect, or a high pressure effect on the brine.

From the log data, the conductivity of the brine was estimated as 0.2 (Ohm-cm)⁻¹ from the EOS model accounting for HP and HT conditions as compared to 0.24 (Ohm-cm)⁻¹ from the model that does not account for any HP or HT effect. The EOS model accounting for HP and HT, accounting for HP and HT effects on the brine only, predicted the hydrocarbon saturation as 68.4% as compared to the model that does not account for any HP or HT effect estimate of 64.7%. A summary of the results in presented in Table 1.

TABLE 1

| | Model Not Account for | Model accounting for HP and |
|---|---|---|
| Properties | HP or HT Effect | HT effect on brine |
| σ (Ω-cm)⁻¹ | 0.24 | 0.2 |
| R_{w}, Ω-m | 0.04 | 0.05 |
| S_{w}, % | 31.6 | 35.3 |
| S_{HC}, % | 68.4 | 64.7 |

As shown above, the model that does not account for any HP or HT effect estimated a greater hydrocarbon saturation as compared to the model which accounts for the HP and HT effects on the brine.

Calculations were also performed to estimate the hydrocarbon saturation using an Equation of State model according to embodiments disclosed herein accounting for a high temperature effect, a pressure effect, and a high pressure effect on the brine and dense gas. Without knowing the production history of the well, two cases were considered. Case 1 assumed the well only produces methane. Case 2 assumed the well produced a mixture of methane, carbon dioxide (20%), water, sodium chloride, potassium chloride and barium sulfate. Using the total resistivity, total porosity and water resistivity from above, the EOS model accounting for HP and HT in the brine and dense gas phase estimated the resistivity of the dense gas phase for case 1 as 2 Ω-m and for case 2 as 2.5 Ω-m. The EOS model accounting for HP and HT also estimated the hydrocarbon saturation of case 1 as 71.9% and for case 2 as 77.7%. A summary of the results in presented in Table 2.

TABLE 2

| | Model accounting for HP | Model accounting for HP and |
|---|---|---|
| | and HT effect on dense | HT effect on dense gas phase |
| Properties | gas phase (case 1) | (case 2) |
| R_{g}, Ω-m | 2 | 2.5 |
| S_{w}, % | 28.1 | 22.2 |
| S_{HC}, % | 71.9 | 77.7 |

As shown above, both cases which account for the HPHT effects on the brine and the dense gas phase provide a hydrocarbon saturation greater than either the model that does not account for any HP or HT effect or the model which only accounts for the HPHT effects on the brine. Because the dense gas phase is conductive, the actual hydrocarbon content of the formation is greater than would be predicted using other methods. The HPHT effects of the dense gas phase and the aqueous phase can provide accurate resistivity measurements for estimating reserves at HPHT conditions. Tools and software may also be calibrated for particular environments of the geological formation.

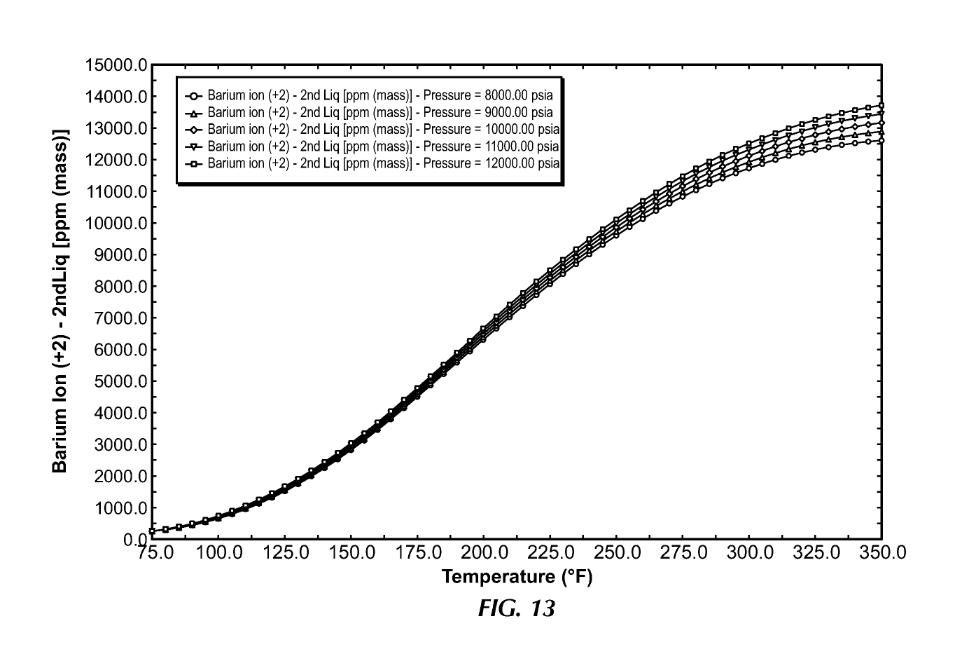

Referring now to FIG. 13, FIG. 13 is a graphical representation of how the Ba²⁺ concentration in a dense gas phase may change as a function of temperature and pressure. While encompassing a limited range of temperatures and pressures, it can be readily appreciated that the dense gas phase may contain a substantial amount of ions that may affect production of a reservoir.

As described above, embodiments disclosed herein account for one or more of a high temperature effect, a pressure effect, and a high pressure effect on the simulated or estimated properties of brines and dense gases encountered in reservoirs. By accounting for such effects, embodiments disclosed herein may allow more accurate characterization of reservoirs, reservoir fluids, or phase(s) or reservoir fluids, more accurately predict hydrocarbon content of the formations encountered during drilling, and allow for extension of such simulations to provide for an increase in efficiency for production of reservoirs of interest. Further, the accurate prediction of the character of the reservoir fluid provided by models described herein, and changes in that character that may occur due to induced chemical interactions and changes in production conditions may provide for improvements in production planning and control.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed:

1. A method for producing fluids from a geological formation, the method comprising:
(a) inputting at least one first property of a geological formation into an equation of state (EOS) model, the EOS model accounting for bound water, a high temperature effect on the brine and a high temperature effect on the dense gas phase;
(b) solving the EOS model to determine a character of fluids contained in the geological formation;
(c) inputting one or more production conditions into the EOS model;
(d) solving the EOS model to determine a character of the fluids based on the determined character of the fluids in the geological formation and the input production conditions;
(e) at least one of:
(i) outputting the solution in (b), (d), a combination thereof, or data derived therefrom to a display device;
(ii) planning production of fluids from the geological formation based on the solutions in (b), (d), or combinations thereof;
(iii) controlling or adjusting production conditions based on the solutions in (b), (d), or combinations thereof.

2. The method of claim 1, further comprising:
measuring the at least one property of the geological formation using a downhole measurement device.

3. The method of claim 1, further comprising repeating (c) and (d) to map a character of the fluids along a production flow channel.

4. The method of claim 1, further comprising repeating (c) and (d) to map a character of the fluids proximate a location along a production flow channel.

5. The method of claim 1, further comprising repeating (c) and (d) to map a change in the character of the fluids over a time period of production.

6. The method of claim 1, wherein the inputting one or more production conditions comprises inputting at least one of a flow rate, a temperature, a concentration, and a type of control agent, the solving further comprising:
determining an effect of the control agent on the character of the fluids at the input production conditions.

7. The method of claim 6, further comprising screening control agents to estimate their potential effectiveness for inhibiting scale formation along a production flow channel or proximate a location in the production flow channel.

8. The method of claim 6, further comprising determining a minimum effective amount of a control agent for inhibiting scale formation along a production flow channel or proximate a location in the production flow channel.

9. The method of claim 6, further comprising adjusting or controlling a flow rate of a control agent to a production flow channel or location in a production flow channel based on the determined effect of the control agent on the character of the fluids.

10. The method of claim 1, wherein the solving the EOS model to determine a character of the fluids based on the determined character of the fluids in the geological formation and the input production conditions further comprises determining a time to transition from an initial production condition to a final production condition.

11. The method of claim 10, further comprising analyzing the determined transition time to determine if the change from the initial production condition to the final production condition is operationally significant.

12. A method for screening control agents used during production of fluids from a geological formation, the method comprising:
(a) inputting at least one first property of a geological formation into an equation of state (EOS) model, the EOS model accounting for bound water, a high temperature effect on the brine and a high temperature effect on the dense gas phase;
(b) solving the EOS model to determine a character of fluids contained in the geological formation;
(c) inputting one or more production conditions into the EOS model, including at least one of a flow rate, a temperature, a concentration, and a type of control agent;
(d) solving the EOS model to determine a character of the fluids based on the determined character of the fluids in the geological formation and the input production conditions to determine an effect of the control agent on the character of the fluids at the input production conditions;
(e) at least one of:
(i) outputting the solution in (b), (d), a combination thereof, or data derived therefrom to a display device;
(ii) planning production of fluids from the geological formation based on the solutions in (b), (d), or combinations thereof;
(iii) controlling or adjusting production conditions based on the solutions in (b), (d), or combinations thereof.

13. The method of claim 12, further comprising screening control agents to estimate their potential effectiveness for inhibiting scale formation along a production flow channel or proximate a location in the production flow channel based on the determined effect.

14. The method of claim 12, further comprising determining a minimum effective amount of a control agent for inhibiting scale formation along a production flow channel or proximate a location in the production flow channel based on the determined effect.

15. The method of claim 12, further comprising adjusting or controlling a flow rate of a control agent to a production flow channel or location in a production flow channel based on the determined effect of the control agent on the character of the fluids based on the determined effect.

16. A method for producing fluids from a geological formation, the method comprising:
(a) inputting at least one first property of a geological formation into an equation of state (EOS) model, the EOS model accounting for bound water, a high temperature effect on the brine and a high temperature effect on the dense gas phase;
(b) solving the EOS model to determine a character of fluids contained in the geological formation;
(c) inputting one or more production conditions into the EOS model;
(d) solving the EOS model to determine scale tendencies of the fluids based on the determined character of the fluids in the geological formation and the input production conditions;
(e) at least one of:
(i) outputting the solution in (d) or data derived therefrom to a display device;
(ii) planning production of fluids based on the determined scale tendencies; and
(iii) controlling or adjusting production conditions based on determined scale tendencies.

17. The method of claim 16, further comprising:
measuring the at least one property of the geological formation using a downhole measurement device.

18. The method of claim 16, further comprising repeating steps (c) and (d) to map scale tendencies of the fluids along a production flow channel.

19. The method of claim 16, further comprising repeating steps (c) and (d) to map scale tendencies of the fluids proximate a location along a production flow channel.

20. The method of claim 16, further comprising repeating steps (c) and (d) to map a change in the scale tendencies of the fluids over a time period of production.
